(19) United States
(12) Patent Application Publication
(10) Pub. No.: US 2025/0274248 A1
(43) Pub. Date: Aug. 28, 2025

(54) INTRA DEVICE INTERFERENCE MANAGEMENT METHOD AND APPARATUS

(71) Applicant: ZTE CORPORATION, Shenzhen (CN)

(72) Inventors: Wenting LI, Shenzhen (CN); Jing LIU, Shenzhen (CN); He HUANG, Shenzhen (CN)

(21) Appl. No.: 18/876,835

(22) PCT Filed: Aug. 3, 2022
(86) PCT No.: PCT/CN2022/110034

§ 371 Date: Dec. 19, 2024

(51) Int. Cl. H04L 5/00

(52) U.S. Cl. CPC H04L 5/0094; H04L 5/0062; H04L 5/0085

(57) ABSTRACT

Methods, system, apparatus for wireless communication include a method of wireless communication includes receiving, by a network device, a report from a wireless device indicative of usability of radio frequency (RF) resources configured for communication with the wireless device and transmitting, by the network device to the wireless device, a reconfiguration command according to the report.

### TECHNICAL FIELD

This document relates to systems, devices and techniques for wireless communications.

### BACKGROUND

Efforts are currently underway to define next generation wireless communication networks that provide greater deployment flexibility, support for a multitude of devices and services and different technologies for efficient bandwidth utilization.

### SUMMARY

This document describes technologies, among other things, techniques for management of intra-device interference conflicts.

In one example aspect, a method of wireless communication is disclosed. The method includes receiving, by a network device, a report from a wireless device indicative of usability of radio frequency (RF) resources configured for communication with the wireless device; and transmitting, by the network device to the wireless device, a reconfiguration command according to the report.

In another example aspect, a method of wireless communication is disclosed. The method includes generating, by a wireless device, a report indicative of usability of radio frequency (RF) resources configured for use by the wireless device for communication with a network device; and transmitting, by the wireless device to the network device, the report.

In yet another example aspect, a wireless communications apparatus comprising a processor is disclosed. The processor is configured to implement methods described herein.

In another example aspect, the various techniques described herein may be embodied as processor-executable code and stored on a computer-readable program medium.

The details of one or more implementations are set forth in the accompanying drawings, and the description below. Other features will be apparent from the description and drawings, and from the claims.

### BRIEF DESCRIPTION OF THE DRAWINGS

FIG. 1 shows an example of a communication device exhibiting intra-device coexistence (IDC) radio frequency (RF) interference.

FIG. 2 shows an example of a spectrum affected by IDC interference.

FIG. 3 shows a signal exchange diagram example in which bandwidth part (BWP) reporting is performed.

FIG. 4 shows an example of a spectrum not affected by IDC interference.

FIG. 5 shows an example of impact of IDC interference between two different protocols.

FIG. 6 shows an example of an IDC reporting procedure.

FIG. 7 is a flowchart for an example method of wireless communication.

FIG. 8 is a flowchart for an example method of wireless communication.

FIG. 9 is a block diagram of an example of a wireless communication apparatus.

FIG. 10 shows an example wireless communications network.

FIG. 11 shows an example frequency division multiplexing (FDM) scenario.

FIG. 12 shows an example frequency division multiplexing (FDM) scenario.

### DETAILED DESCRIPTION

Section headings are used in the present document only to improve readability and do not limit scope of the disclosed embodiments and techniques in each section to only that section. Furthermore, some embodiments are described with reference to Third Generation Partnership Project (3GPP) New Radio (NR) standard (“5G”) for ease of understanding and the described technology may be implemented in different wireless system that implement protocols other than the 5G protocol.

The current IDC (In-Device Coexistence) solution in NR is based on the carriers, thus the affected frequencies cannot be adequately indicated via the NR FDM (frequency division multiplexing) solution.

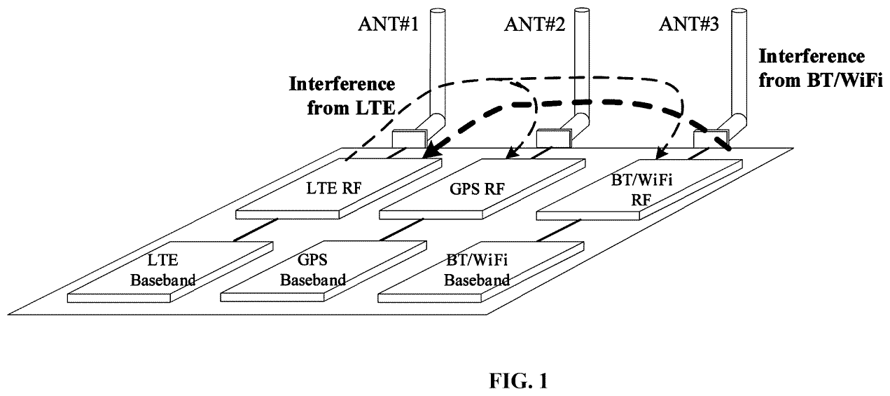

Due to extreme proximity of multiple radio transceivers within a same wireless device (sometimes called user equipment UE), the transmit power of one transmitter may be much higher than the received power level of another receiver as shown in FIG. 1.

As depicted in the embodiment in FIG. 1, a UE may comprise multiple transmit/receive chains that each may have corresponding one or more antennas. Here, three transmit/receive chains are shows—the leftmost is an LTE (Long Term Evolution) transmit/receive chain that includes Antenna 1 coupled to an LTE RF section (e.g., RF integrated circuit and other components), and an LTE baseband processor. The middle transmit/receive chain includes a global positioning system (GPS) section with a corresponding antenna 2, and GPS RF and baseband processing modules (typically integrated circuits or programmable processors). The rightmost transmit/receive chain comprises Bluetooth and/or Wi-Fi circuits (RF and baseband) with corresponding antenna 3. During operation, interference may be of two types with respect to the 3GPP circuitry (LTE or may also be NR). The incoming interference or ingress interference may affect LTE transmission/reception operation and may be generated by the GPS or the Bluetooth/Wi-Fi circuitry. The other type of interference is interference that is caused by the LTE circuitry and affecting the GPS and Bluetooth or Wi-Fi operation.

To solve these issue, IDC related mechanism was introduced in LTE. According to the LTE protocol, the IDC would be triggered for both the serving frequency and non-serving frequency when the network indicates to report IDC assistance information. Furthermore, both the current frequency experiencing IDC problems and the potential IDC problems on the secondary frequency and the non-serving frequency (for which a measurement object is configured) shall be reported. Then, with the development of 5G, a similar IDC scheme was also introduced for the NR and dual connectivity (EN-DC) case.

Furthermore, in the wireless communication, the bandwidth part (BWP) concept was introduced to the wireless communication system. A BWP may represent a contiguous set of physical resource blocks (PRBs) on a given carrier. For each cell, the network can configure multiple BWPs though only one BWP can be activated. Meanwhile, the UE will report its capability according to the network's requirements. For a DC (dual connection)/CA (carrier aggregation) scenario, the network will configure the BWP of each band entry according to the UE BC (Band Combination) capability. The network can switch the BWP by a radio resource control (RRC) signaling, downlink control information DCI, BWP inactivity timer or random access (RA) procedure. Typically, the RRC signaling has the longest delay among all these methods. With all of these methods, each BWP was activated or deactivated individually by its corresponding control information. For example, in the DCI, there is a bandwidth part indicator to indicate which BWP would be activated/inactivated of the current serving cell. An example is shown in Table 1.

TABLE 1
Value of BWP indicator field

| Value of BWP | |
|---|---|
| indicator field | |
| 2 bits | Bandwidth part |
| 00 | Configured BWP with BWP-Id = 1 |
| 01 | Configured BWP with BWP-Id = 2 |
| 10 | Configured BWP with BWP-Id = 3 |
| 11 | Configured BWP with BWP-Id = 4 |

In the 3GPP Rel 18, it was agreed to do enhancement to the IDC frequency division multiplexing (FDM) solution to allow more granular indication of affected frequencies (e.g., granularity of bandwidth part BWP or physical resource block PRB level).

In the legacy scheme (e.g., LTE), for the IDC reporting, the network would indicate a list of “center frequency”.

For NR, the network would indicate a candidateServingFreqList with ARFCN (absolute radio frequency channel number) value. An example is shown in Table 2.

TABLE 2
IDC-AssistanceConfig-r16 ::= SEQUENCE {
candidateServingFreqListNR-r16 CandidateServingFreqListNR-r16
OPTIONAL, -- Need M ...}
CandidateServingFreqListNR-r16 ::= SEQUENCE (SIZE (1..maxFreqIDC-r16)) OF
ARFCN-ValueNR

While for the E-UTRA (Evolved Universal Mobile Telecommunications System terrestrial radio access), the UE would take the frequencies for which a measurement object is configured into consideration.

Then the UE would report the affected frequencies to the network with 2 different IDC interference types:
IDC interference from or to 3GPP single carrier (together with interference direction);
IDC interference caused by 3GPP uplink (UL) CA or DC to the Industrial Scientific Medical or Global navigational satellite system (ISM/GNSS) frequencies, together with victim type.

At the network side, the network would determine how to move the 3GPP signal away from the ISM/GNSS band based on the UE reported center frequencies together with the interference direction or the victim type. The network may perform inter-frequency handover, removing SCells from the set of serving cells or de-activation of affected SCells, or in case of uplink CA operations, allocate uplink PRB resources on component carriers CC(s) whose inter-modulation distortion and harmonics does not fall into the frequency range of the victim system receiver.

The present document provides, among other thigs, solutions to the IDC FDM enhancement methods that provide greater flexibility and granularity control than the existing schemes. Some example embodiments, the technical problems posed by such embodiments, and technical solutions that address and overcome these problems are illustrated throughout the present document.

### INTRODUCTION TO EMBODIMENTS

For a scenario that the BWP is only configured for the Serving cell, for the serving frequency (there is serving cell on the frequency) and non-serving frequency, different enhancement method can be adopted.

For example, the UE can report the BWP level IDC for some frequencies (e.g., serving frequency) and/or PRB level IDC for the other frequencies (e.g., non-serving frequency) or no enhancement for the other frequencies.

In some embodiments the UE makes the decision according to the network configuration. Alternatively, or in addition, UE may take the decision regarding how to report IDC.

For the UE determination, the UE can determine based on whether there is BWP that is not affected by the IDC; if there is, then the UE can report the BWP level IDC for that frequency.

For embodiments in which network configuration is used, the network can request the UE to report the BWP level IDC for some frequencies (e.g., serving frequency) and/or PRB level reporting for the other frequencies (e.g., non-serving frequency).

### Issue 1: BWP-Based IDC Interference Solving

Issue description: In the legacy scheme, the UE can only indicate the carrier frequency into the network, the network would take this assistance information to determine whether handover is needed and the target frequencies. When the BWP is considered, there is a case that only parts of BWP would be affected by the IDC interference. If the network gets the BWP-based or PRB based information, the network can also solve the IDC interference with BWP switch or reconfiguration.

### Example Solutions

In some embodiments the UE reports the BWP not affected by the IDC interference, or the BWP combinations that are not affected by the IDC interference to the network. Alternatively, this information is implicitly indicated by reporting affected BWP and BWP combination.

In some embodiments, the UE can also report the not affected PRB range or not affected PRB ranges information to the network.

In some embodiments, whether to report the affected BWP/PRB or the not affected BWP/PRB can be configured by the network.
In some embodiments, the network may perform BWP or BWP combination switching according to the UE reported information.

### Example 1: Allowed BWP Reporting

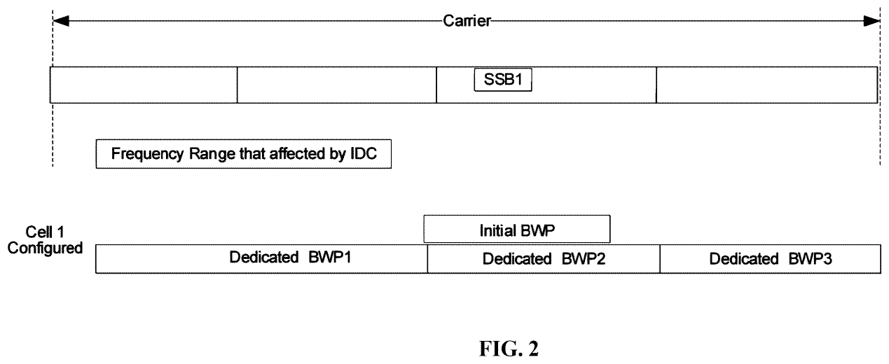

As shown in the FIG. 2, assume only the dedicated BWP1 was affected by the IDC interference, and the BWP1 is activated, the UE detects the IDC interference.

The UE can indicate BWP2 and BWP3 to the network (which represent allowed BWP because there is no IDC), then the network can switch the UE from the BWP1 to the BWP2 or BWP3.

### Example 2: Allowed BWP Reporting—General Procedure

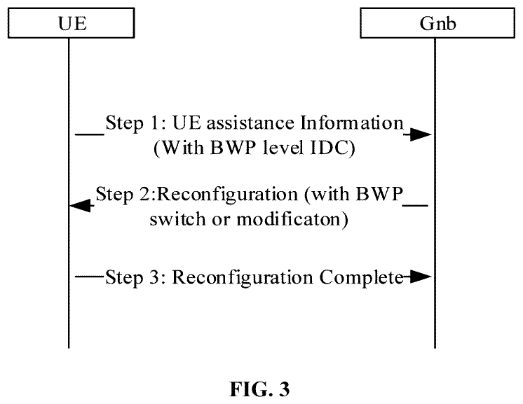

FIG. 3 shows an example procedure for reporting allowed BWP (or the BWP that not affected by the IDC). This procedure may proceed as follows.

In step 1, UE may report UE assistance information to the network device (e.g., a base station). The UE assistance information may include IDC information at BWP level.

In step 2, in response to the UE assistance information, the network may issue a reconfiguration message to the UE. In the reconfiguration message, the network may specify that BWP is to be switched or modified.

In step 3, based on the received reconfiguration message, UE may perform the switching or reconfiguration instructed by the network. Upon completion of this action, UE may report back a reconfiguration complete message indicating that reconfiguration has been completed. In some embodiments, the procedure depicted in FIG. 3 may be implemented under network control such as when initiated by the network.

### Example 3: Allowed BWP Reporting Signal

Table 3 shows an example of contents of a message that reports allowed BWP from UE to the network.

TABLE 3

```
allowedBwpList ::= SEQUENCE (SIZE (1.. maxBWPIDC)) OF
allowedBwp
allowedBwp ::= SEQUENCE {
  serCellIndex Integer( ),
    allowedDLBwpperCellList ::= SEQUENCE (SIZE (1..
maxBWPIDC)) OF allowedBwpperCell
    AffecteUDLBwpperCellList ::= SEQUENCE (SIZE (1..
maxBWPIDC)) OF allowedBwpperCell
```

### Example 4: Allowed BWP Combination (or the BWP Combination that are not Affected by the IDC) Reporting Signal

Table 4 shows an example of contents of a message that reports allowed BWP combinations from UE to the network.

TABLE 4

| allowedBWPCombList ::= SEQUENCE (SIZE (1..maxCombIDC)) OF | |
|---|---|
| allowedBWPComb | |
| allowedBWPComb ::= | SEQUENCE { |
| allowedBWPComb | SEQUENCE (SIZE (2..maxNrofServingCells)) |
| OF BWPIndex OPTIONAL, | |
| victimSystemType-r16 | VictimSystemType-r16} |
| BWPIndex ::= | SEQUENCE {serCellIndex BWPID} |

### Example 5: UE Indicate the PRB Range that are not Affected by the IDC Interference

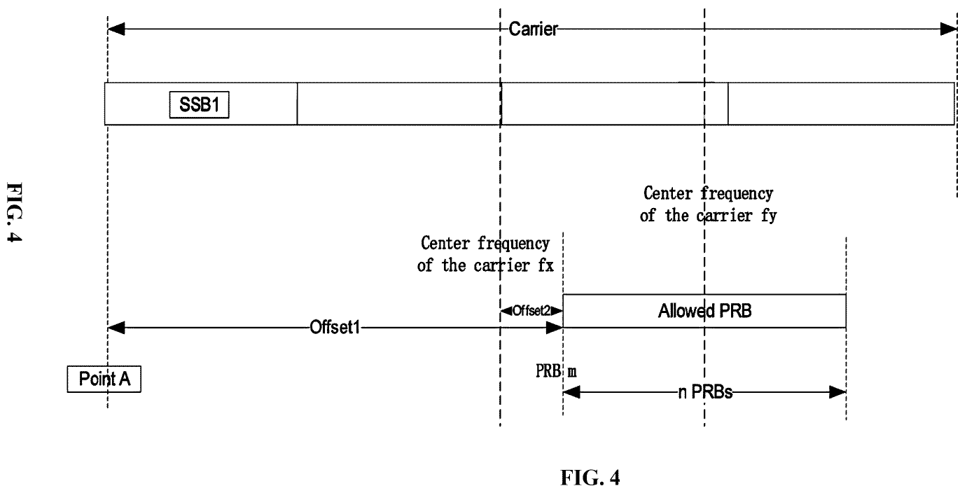

FIG. 4 shows an example of spectrum in which PRB range that are not affected by IDC interference are reported. Table 5 shows an example syntax of the allowed PRB list reported from the UE to the network.

TABLE 5

| | |
|---|---|
| AllowedPRBList ::= | SEQUENCE (SIZE (1.. maxPRBIDC)) OF AllowedPRB |
| AllowedPRB ::= | SEQUENCE { |
| centrefrequency | ARFCN-ValueNR; |
| offset 1 | Offset; |
| Range | bandwidth/Number of PRBs} |

OR

| | |
|---|---|
| AffectedPRB ::= | SEQUENCE { |
| centrefrequency | ARFCN-ValueNR; |
| Range | bandwidth/Number of PRBs |

OR

| | |
|---|---|
| AffectedPRB ::= | SEQUENCE { |
| Point A | ARFCN-ValueNR; |
| Offset2 | Offset; |
| Range | bandwidth/Number of PRBs } |

In some embodiments, when the network gets the allowed PRB range(s), the network may decide to configure the UE within the allowed PRB range(s). In some embodiments, the UE can also indicate allowed PRB ranges combinations for the UL CA/DC case.

### Issue 2: IDC Interference Level Reporting

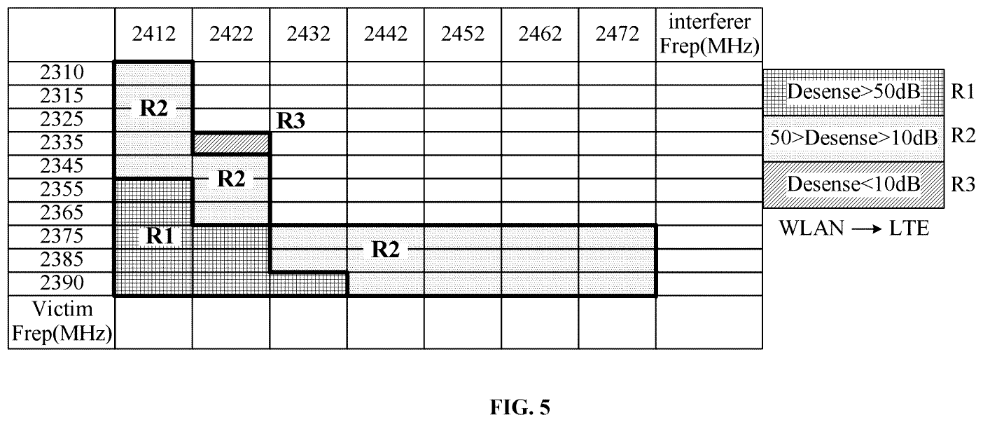

Issue description: For the BWP/PRB level reporting, the UE can report the dedicated BWP/PRBs that are affected by the IDC issues. According to the simulation results in the Annex A.2 of 36.816 (e.g., FIG. 5) the IDC interference sensitivity would be different for the different frequency ranges. For example, in FIG. 5, a two-dimensional grid of interferer frequencies (horizontal axis) and affected victim frequencies (vertical axis) is shown. The relative values of the interference are reflected by the shading of the corresponding grid cells. The report may include multiple levels of interference sensitivity. In the embodiment depicted in FIG. 5, three levels are indicated: a first level with de-sensitivity greater than 50 dB, a second level with de-sensitivity between 50 and 10 dB, and a third level with de-sensitivity below 10 dB. This particular case may correspond to interference from a wireless local area network (WLAN) network (e.g., Wi-Fi) to an LTE network.

From the network side, if the UE can indicate the IDC interference sensitivity level for each BWP/PRB range, the network can make more precise resource control.

### Example Solutions

### Solution 1: UE Indicates the IDC Interference Level for the Affected BWP/PRB Range

Network can configure the threshold for the different sensitivity level for the UE reporting
e.g., the number of levels and the upper and/or lower threshold for each level.
When the IDC interference level information are different from the previous reported, the UE triggers IDC interference assistance information reporting
Then IDC interference level can be expressed from the desensitization aspect.
   Solution 2: UE Indicate the BWP/PRB Range that are not Affected by the IDC Interference
The network configures the UE only within the allowed BWP/PRB.

In the below examples, the PRB range is used as an example, however, similar technique can also be used for the BWP level reporting method, with the PRB range being replaced with the BWP or BWP combination.

### Example 6: UE Report the Affected PRB Ranges with Interference Level Information for the Affected Frequency

Table 6 shows an example of the configuration of an interference level reporting message that may be used by embodiments.

TABLE 6

| PRB range for a frequency | Interference level |
|---|---|
| PRB range 1 | High |
| PRB range 2 | Medium |
| PRB range 3 | Low |

The signaling syntax can be as shown in Table 7 below:

TABLE 7

| | |
|---|---|
| AffectedPRBList ::= | SEQUENCE (SIZE (1.. maxPRBIDC)) OF |

AffectedPRB

| | |
|---|---|
| AffectedPRB ::= | SEQUENCE { |
| centrefrequency | ARFCN-ValueNR; |
| offset | ; |
| Range | bandwidth/Number of PRBs |

Interference level Enum (High, medium, low, spare) }
OR

| | |
|---|---|
| AffectedPRB ::= | SEQUENCE { |
| centrefrequency | ARFCN-ValueNR; |
| Range | bandwidth/Number of PRBs |

Interference level Enum (High, medium, low, spare) }

### Example 7: UE Report the Affected PRB Ranges Combination with Interference Level Information

For the case that the report PRB ranges combination for the UL CA or DC case, the UE can also indicate the interference level for each PRB ranges combination. In Table 8, f1 and f2 represent carrier frequencies used in the CA or DC case.

TABLE 8

| PRB ranges combination | Interference level |
|---|---|
| PRB range 1 on f1 + PRB range 2 on f1 | High |
| PRB range 1 on f1 + PRB range 3 on f2 | Medium |

The signaling can be as shown in Table 9 below:

TABLE 9
AffectedPRBCombList ::= SEQUENCE (SIZE (1..maxCombIDC))
OF AffectedPRBComb
AffectedPRBComb ::= SEQUENCE {

| | |
|---|---|
| affectedPRBComb | SEQUENCE (SIZE (2..maxNrofcarriers)) |

OF AffectedPRBList
OPTIONAL,
Interference level Enum (High, medium, low, spare)

| | |
|---|---|
| victimSystemType-r16 | VictimSystemType-r16} |

### Example 8: The Network Configures One or More Threshold for the Interference Level Reporting

In this example, network indicates threshold within “Other config” for the Reconfiguration message, it can require the UE to report the IDC interference that stronger than the threshold, or it can also require the UE to report the IDC interference weaker than the threshold. An example of a configuration provided by the network is shown in Table 10.

TABLE 10

| PRB range for a frequency | Interference level |
|---|---|
| PRB range 1 | Level 1: Stronger than the threshold |
| PRB range 2 | Level 2: Lower than the threshold |

The network can also indicate more than 1 thresholds, e.g., Threshold 1 and threshold 2. Table 11 shows an example of contents of such a message.

TABLE 11

| PRB range for | |
|---|---|
| a frequency | Interference level |
| PRB range 1 | Level 1: Stronger than the threshold 1 |
| PRB range 2 | Level 2: Lower than the threshold1 but |
| | stronger than the threshold 2 |
| PRB range 2 | Level 3: Lower than the threshold2 |

### Example 8: The UE Trigger the IDC Interference Level Reporting

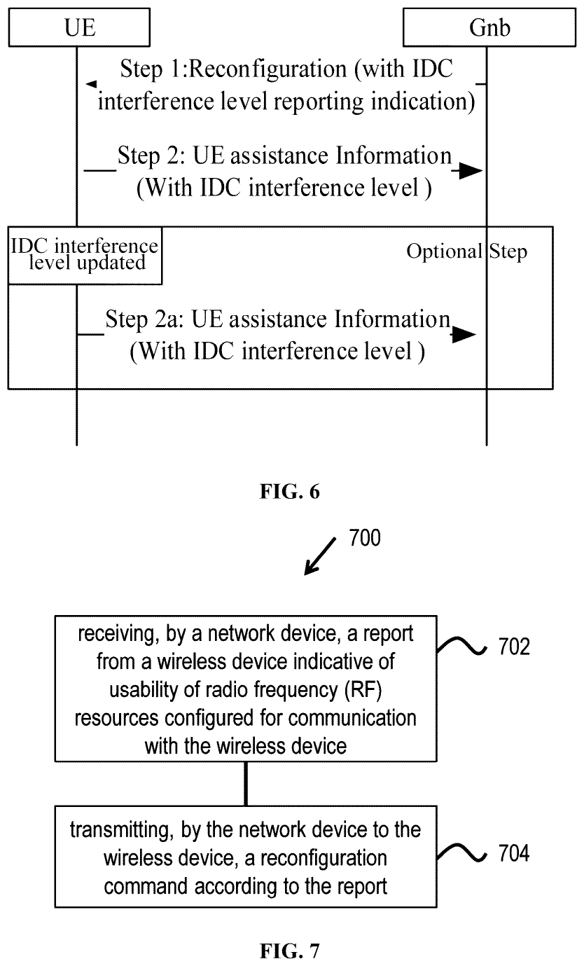

FIG. 6 shows an example of a procedure for reporting IDC interference level reporting. Referring to FIG. 6, at step 1, network may transmit, and UE receive, a reconfiguration message. This message includes an IDC interference level reporting indication such as described in the present document.

At step 2, UE may provide a report of IDC interference levels. This report may be provided in a UE assistance information message. In some embodiments, optionally, upon noticing that IDC interference levels have changed, UE may subsequently transmit another UE assistance information message that included the updated IDC interference level information. This optional step may be reported multiple times responsive to changes to IDC interference level.

In some embodiments, the UE may trigger the IDC interference level reporting when the network indicates to report IDC interference level or when the network indicates different thresholds from the previous one or when the IDC Interference level information at UE side was updated.

In some embodiments, the interference level information may also include the corresponding PRBs.

As described above, for the BWP based scheme, if the UE report the affected BWP (or the affected BWP combination for the CA/DC case) for the IDC interference, the interference level can also be reported as the above PRB based scheme has done.

### Issue 3: UE Capability Reporting and Other

(1) For the BWP-based or PRB-based reporting, the UE can indicate the related capabilities to the network, including a capability to indicate the UE support BWP-based IDC reporting or a capability to indicate supporting PRB-based reporting or a capability to indicate the UE support IDC interference level reporting.

(2) For the BWP/PRB level IDC reporting, the UE can repot BWP combination index or PRB combination index.

For the BWP combination index based reporting, the BWP combination index can be set according to a predefined rule. While the PRB combination index can be set with 2 steps:
Step 1: give an index for each PRB range
Step 2: give an index for each PRB range combination according to a predefined rule.

Discussion of enhancements to FDM scenarios

This section discusses examples of enhancements provided to serving frequency and non-serving frequency, as described previously in the present document.

### FDM Enhancement for the NR Serving Frequency

For the BWP reporting, the UE may report which BWPs are affected (or not affected) by the IDC interference. Then the network can further determine how to solve the IDC issues, e.g., switch the UE to another BWP or handover the UE to another cell and so on. According to the legacy rule, both the on-going and the expected IDC interference shall be reported, so for the BWP based reporting, a configured BWP is considered.

For the PRB reporting, the UE may report which PRBs are affected (or not affected) by the IDC interference, then the network may determine the next action based on the information.

The PRB-based reporting can provide more IDC interference information then the BWP-based scheme at the cost of a little more signaling overhead.

A single carrier scenario is first disclosed, then the CA/DC scenario. For the single carrier case, it can be further divided into 2 scenarios:

Scenario 1: Only part of configured BWPs are affected.

Scenario 2: All of the configured BWPs are affected.

Scenario 1 has been disclosed previously with respect to FIG. 2.

With the BWP reporting, the UE can indicate the affected BWP1 (or the BWP2 that is not affected) to the network, then the network can switch the UE from the BWP1 to the BWP2.

With the PRB reporting, the network would need to determine which BWP is still available based on the PRB info, which would also increase the network implementation complexity.

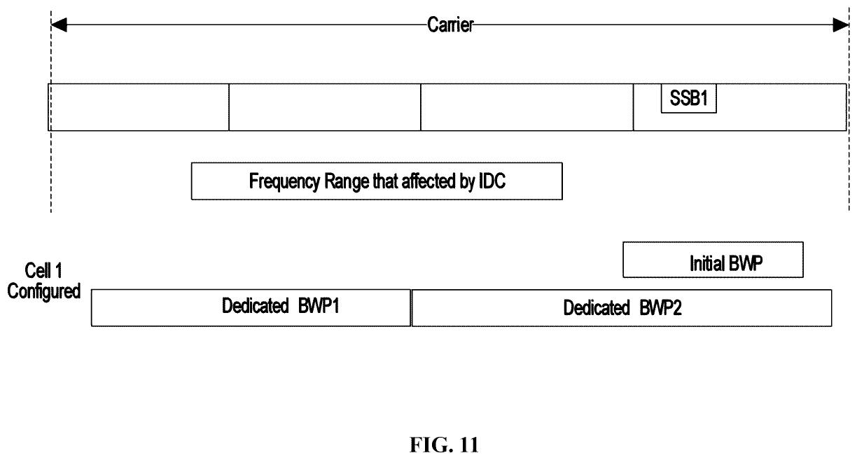

For the scenario 2, FIG. 11 shows as an example. Here, both dedicated BWP1 and BWP2 are affected by the IDC interference.

With the BWP reporting, the UE would indicate both 2 dedicated BWPs, then the network would have to handover the UE to the other cell with FDM solution.

With the PRB reporting, the UE would report the dedicated affected PRBs, then the network can solve the IDC issue by either BWP reconfiguration or handover. However, for the BWP reconfiguration method, the bandwidth may also be affected.

Therefore, for the scenario 2, with dedicated PRBs reporting, the network may not need to handover the UE to the other cell by reconfiguration the BWP.

The above is about the single CC case, for the CA/DC case, it would be more complex. Here we take the CA as an example. Assuming that there are 2 CCs, for each CC there are 2 BWPs as below:
1. Cell 1: UL BWP 1+Cell 2: UL BWP 1
2. Cell 1: UL BWP 1+Cell 2: UL BWP2—Have IDC interference to non-3gpp RAT
3 Cell 1: UL BWP2+Cell 2: UL BWP 1—Have IDC interference to non-3 gpp RAT
4. Cell 1: UL BWP2+Cell 2: UL BWP2

With the BWP reporting, the UE can indicate the affected BWP combination (or the BWP combinations that are not affected) to the network, then the network can switch the UE to the available BWP combination.

With the PRB reporting, it may need to indicate different PRB ranges combination, then at the network side, it would need to determine which BWP combination are not affected by the reported PRB based IDC interference information.

For the CA/DC case, it is more complex to report PRB ranges combination from UE side. From the network side, it's also much complex to derive the available BWP combinations based on the reported PRB information. Compared with the BWP and PRB based scheme, the other difference is that when the BWP configuration changed, the UE may need to report the BWP-level IDC interference. However, such case can be seen as a corner case for that once the network reconfigure the BWP, the previous report IDC info shall be taken into consideration to avoid the on-going or potential IDC interference.

Therefore, in some embodiments, for IDC interference that affect the NR serving frequency, take the BWP-based scheme may be used as baseline.

As described before, if BWP level IDC reporting was supported, the network may perform BWP switching/modification to solve the IDC interference, the general procedure can be as discussed with respect to FIG. 3.

For the BWP level IDC reporting, there may be two possible implementation scenarios:

Option 1: The configured BWP that affected by the IDC interference.

Option 2: The configured BWP that not affected by the IDC interference.

For the Option 1, the network may determine the available BWP based on the reported information, while for the option 2, the network only need to select available BWP from the UE reported.

### FDM Enhancement for the Other Frequency

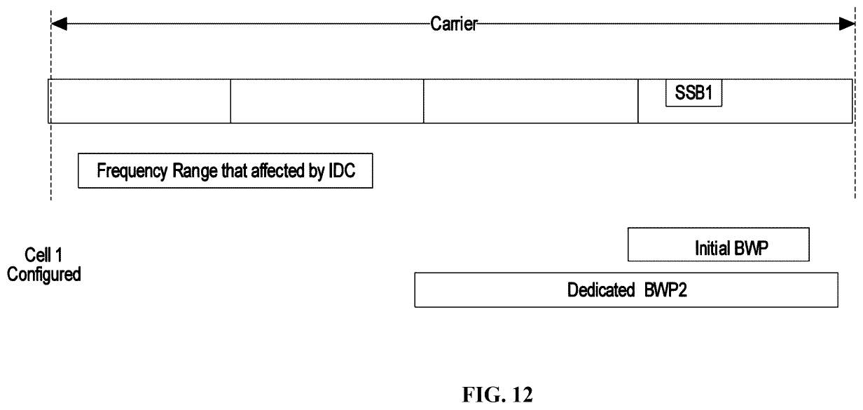

FIG. 12 depicts a scenario relevant to such a scenario. As previously described, besides the NR serving frequency, the UE can also report the Eutra frequency and the NR non serving frequency. For these frequencies, no BWP are configured. So the FDM solution can be enhanced from the PRB aspect. E.g., report the affected PRB (or the not affected PRB). For the NR non-serving frequency, if it was affected by the IDC interference, it would be reported with carrier info in the legacy signaling and the network would avoid to handover the UE to that carrier.

If the PRB level info was reported for the non-serving frequency, the network may select the cell on that non-serving frequency but avoid to allocate the PRB that affected by IDC interference.

However, it's for the non-serving frequency, so it may even not be used at network side especially for the case that the network can solve the existing IDC interference by BWP switching cases.

Here, there may be two different IDC interference types:
IDC interference from or to 3GPP single carrier (together with interference direction);
IDC interference caused by 3GPP UL CA or DC to the ISM/GNSS (together with victim type).

For the type 1, if PRB level was supported, the UE would report the affected PRB ranges for the corresponding frequency. But for the type 2, it would mean that the UE reports PRB ranges combination, which would be more complex.

Some preferred embodiments may incorporate the following solutions.

For example, a network node, e.g., a base station, may implemented the following solutions.

1. A method of wireless communication (e.g., method 700 depicted in FIG. 7), comprising: receiving (702), by a network device, a report from a wireless device indicative of usability of radio frequency (RF) resources configured for communication with the wireless device; and transmitting (704), by the network device to the wireless device, a reconfiguration command according to the report. Various examples of the report and reconfiguration command are described throughout the present document, including, e.g., Tables 1 to 11.

2. The method of solution 1, wherein the report is based on an estimated intra-device radio frequency interference at the wireless device.

3. The method of any of solutions 1-2, wherein the report provides the usability of RF resources according to a frequency domain granularity.

4. The method of solution 4, wherein the frequency domain granularity is at a bandwidth part level or a bandwidth part combination level.

5. The method of solution 5, wherein the frequency domain granularity is at a physical resource block (PRB) level.

6. The method of solutions 4-5, wherein a BWP level granularity is used for a serving cell or a PRB level granularity is used for a non-serving frequency.

7. The method of any of solutions 1-6, wherein the report provides a list of usable RF resources.

8. The method of any of solutions 1-7, wherein the report provides a list of unusable RF resources.

9. The method of any of solutions 1-8, wherein the reconfiguration command causes the wireless device to switch to another bandwidth part or another bandwidth part combination according to the reconfiguration command.

10. The method of solution 9, wherein the reconfiguration command is included in a medium access control element (MAC CE).

11. The method of solution 9, wherein the reconfiguration command is included in a radio resource control (RRC) message.

12. The method of any of solutions 1-11, wherein the report is generated in response to a request from the network device.

13. The method of any of solutions 1-12, wherein the report is formatted according to a report configuration transmitted by the network device.

14. The method of solution 13, wherein the report configuration provides threshold information for a decision regarding intra-device RF interference.

15. The method of solution 13, wherein the report configuration specifies levels of interference to be reported in the report.

For example, a wireless device, e.g., UE, may implement the following solutions.

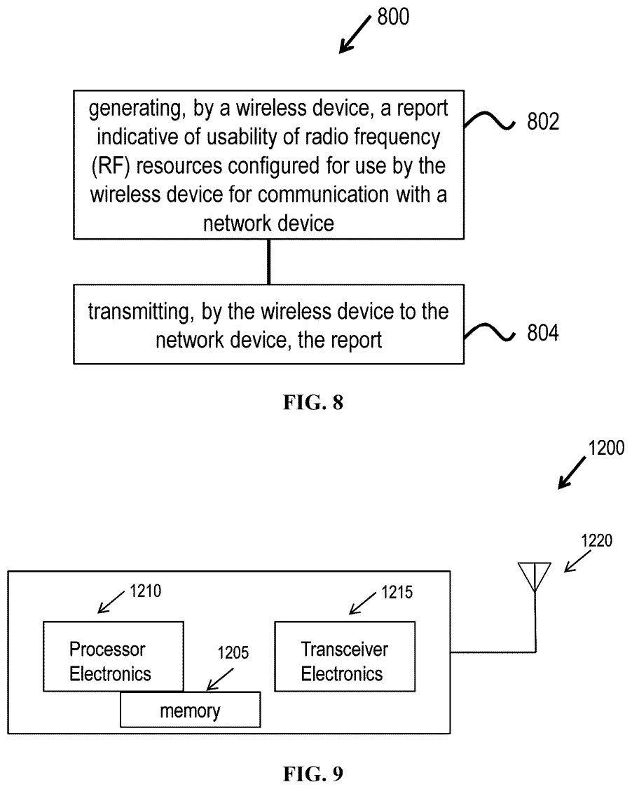

16. A method of wireless communication (e.g., method 800 depicted in FIG. 8), comprising: generating (802), by a wireless device, a report indicative of usability of radio frequency (RF) resources configured for use by the wireless device for communication with a network device; and transmitting (804), by the wireless device to the network device, the report. Various examples of the report and reconfiguration command are described throughout the present document, including, e.g., Tables 1 to 101.

17. The method of solution 16, wherein the report is generated by estimating intra-device RF interference of the wireless device.

18. The method of any of solutions 16-17, wherein the report includes bandwidth part (BWP) or physical resource block (PRB) interference level information.

19. The method of any of solutions 16-18, wherein the report is generated in response to a request from the network device.

20. The method of any of solutions 16-19, wherein the report is formatted according to a report configuration received from the network device.

21. The method of solution 20, wherein the report configuration provide threshold information for a decision regarding intra-device RF interference.

22. The method of solution 20, wherein the report configuration specifies levels of interference to be reported in the report.

23. The method of solution 18, wherein a BWP level granularity is used for a serving cell or a PRB level granularity is used for a non-serving frequency.

24. The method of any of above solutions, wherein the report provides a list of usable RF resources.

25. The method of any of above solutions, wherein the report provides a list of unusable RF resources.

26. The method of any of solutions 1-10, wherein the wireless device received a configuration command responsive to the report, wherein the reconfiguration command causes the wireless device to switch to another bandwidth part or another bandwidth part combination according to the reconfiguration command.

27. The method of solution 23, wherein the reconfiguration command is received as a medium access control element (MAC CE).

28. The method of solution 23, wherein the reconfiguration command is received as a radio resource control (RRC) message.

29. A wireless communication apparatus comprising a processor configured to implement a method recited in any of solutions 1-28.

30. A computer readable medium having code stored thereupon, the code, upon execution, causing a processor to implement a method recited in any of solutions 1-28.

FIG. 9 is a block diagram of an example implementation of a wireless communication apparatus 1200. The methods 700 or 800 may be implemented by the apparatus 1200. In some embodiments, e.g., when implementing method 700, the apparatus 1200 may be a base station or a network device of a wireless network. In some embodiments, e.g., when implementing method 800, the apparatus 1200 may be a user device. The apparatus 1200 includes one or more processors, e.g., processor electronics 1210, transceiver circuitry 1215 and one or more antenna 1220 for transmission and reception of wireless signals. The apparatus 1200 may include memory 1205 that may be used to store data and instructions used by the processor electronics 1210. The apparatus 1200 may also include an additional network interface to one or more core networks or a network operator's additional equipment. This additional network interface, not explicitly shown in the figure, may be wired (e.g., fiber or Ethernet) or wireless.

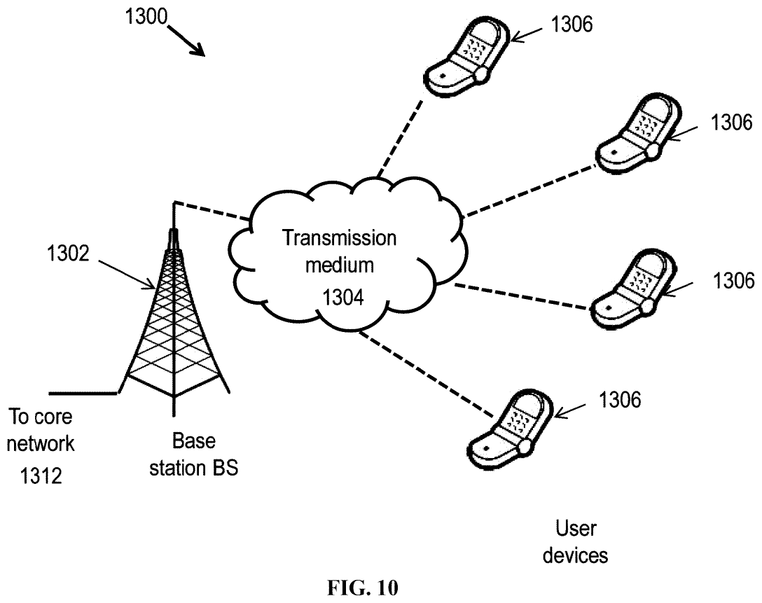

FIG. 10 depicts an example of a wireless communication system 1300 in which the various techniques described herein can be implemented. The system 1300 includes a base station 1302 that may have a communication connection with core network (1312) and to a wireless communication medium 1304 to communicate with one or more user devices 1306. The user devices 1306 could be smartphones, tablets, machine to machine communication devices, Internet of Things (IoT) devices, and so on.

It will be appreciated that the present document provides various techniques that may be implemented by embodiments of UE or network in which IDC measurement and reporting may be controlled at PRB or BWP level. In one advantageous aspect, an interference level information may be provided by UE to the network at BWP, BWP combination or PRB level, allowing the network to make a decision regarding switching or reconfiguring the UE such that ill effects of IDC are mitigated.

It will further be appreciated that the present document provides several enhancement to the existing IDC schemes. For example, in some embodiments, for BWP reporting, all of the configured BWPs (not just the active BWPs) will be considered and used for IDC reporting. For PRB reporting. For the PRB reporting, the UE would report which PRBs are affected (or not affected) by the IDC interference, then the network would determine the next action based on the information. The PRB-based reporting can provide more IDC interference information then the BWP-based scheme at the cost of a little more signaling overhead.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method of wireless communication, comprising:
receiving, by a network device, a report from a wireless device indicative of usability of radio frequency (RF) resources configured for communication with the wireless device; and
transmitting, by the network device to the wireless device, a reconfiguration command according to the report.

2. The method of wireless communication of claim 1, wherein the report is based on an estimated intra-device radio frequency interference at the wireless device.

3. The method of wireless communication of claim 1, wherein the report provides the usability of RF resources according to a frequency domain granularity.

4. The method of wireless communication of claim 3, wherein the frequency domain granularity is at a bandwidth part (BWP) level or a bandwidth part combination level; or
wherein the frequency domain granularity is at a physical resource block (PRB) level;
wherein a BWP level granularity is used for a serving cell or a PRB level granularity is used for a non-serving frequency.

5. (canceled)

6. (canceled)

7. The method of wireless communication of claim 1, wherein the report provides a list of usable RF resources.

8. The method of wireless communication of claim 1, wherein the report provides a list of unusable RF resources.

9. The method of wireless communication of claim 1, wherein the reconfiguration command causes the wireless device to switch to another bandwidth part or another bandwidth part combination according to the reconfiguration command;
wherein the reconfiguration command is included in a medium access control element (MAC CE), or the reconfiguration command is included in a radio resource control (RRC) message.

10. (canceled)

11. (canceled)

12. The method of wireless communication of claim 1, wherein the report is generated in response to a request from the network device.

13. The method of wireless communication of claim 1, wherein the report is formatted according to a report configuration transmitted by the network device.

14. The method of wireless communication of claim 13, wherein the report configuration provides threshold information for a decision regarding intra-device RF interference; or wherein the report configuration specifies levels of interference to be reported in the report.

15. (canceled)

16. A method of wireless communication, comprising:
generating, by a wireless device, a report indicative of usability of radio frequency (RF) resources configured for use by the wireless device for communication with a network device; and
transmitting, by the wireless device to the network device, the report.

17. The method of wireless communication of claim 16, wherein the report is generated by estimating intra-device RF interference of the wireless device.

18. The method of wireless communication of claim 16, wherein the report includes bandwidth part (BWP) or physical resource block (PRB) interference level information;
wherein a BWP level granularity is used for a serving cell or a PRB level granularity is used for a non-serving frequency.

19. The method of wireless communication of claim 16, wherein the report is generated in response to a request from the network device.

20. The method of wireless communication of claim 16, wherein the report is formatted according to a report configuration received from the network device.

21. The method of wireless communication of claim 20, wherein the report configuration provides threshold information for a decision regarding intra-device RF interference; or
wherein the report configuration specifies levels of interference to be reported in the report.

22. (canceled)

23. (canceled)

24. The method of wireless communication of claim 16, wherein the report provides at least one of a list of usable RF resources, or a list of unusable RF resources.

25. (canceled)

26. The method of wireless communication of claim 16, wherein the wireless device receive s a reconfiguration command responsive to the report, wherein the reconfiguration command causes the wireless device to switch to another bandwidth part or another bandwidth part combination according to the reconfiguration command;
wherein the reconfiguration command is received as a medium access control element (MAC CE), or the reconfiguration command is received as a radio resource control (RRC) message.

27. (canceled)

28. (canceled)

29. A wireless communication apparatus comprising a processor configured to implement the following:
receiving a report from a wireless device indicative of usability of radio frequency (RF) resources configured for communication with the wireless device; and
transmitting a reconfiguration command according to the report.

30. A non-transitory computer readable medium having code stored thereupon, the code, upon execution, causing a processor to implement a method of wireless communication recited in claim 1.
